(19) United States
(12) Patent Application Publication
(10) Pub. No.: US 2002/0054211 A1
(43) Pub. Date: May 9, 2002

(54) Surveillance video camera enhancement system

(76) Inventors: Steven D. Edelson, Wayland, MA (US); Klaus Diepold, Siegertsbrunn (DE)

Correspondence Address: VENABLE, BAETJER, HOWARD AND CIVILETTI, LLP, P.O. BOX 34385, WASHINGTON, DC, 20043-9998, US

(21) Appl. No.: 09/985,544

(22) Filed: Nov. 5, 2001

Related U.S. Application Data
(60) Provisional application No. 60/245,710, filed on Nov. 6, 2000.

(51) Int. Cl. H04N 7/18

(52) U.S. Cl. 348/169; 348/143; 348/152; 348/153; 348/154; 348/155

(57) ABSTRACT

In a video camera surveillance system, a video processor determines dense motion vector fields between adjacent frames of the video. From the dense motion vector fields moving objects are detected and objects undergoing unexpected motion are highlighted in the display fo the video. To distinguish expected motion from unexpected motion, dense motion vector fields are stored representing expected motion and the vectors representing the moving object are compared with the stored vectors to determine whether the object motion is expected or unexpected. In an alternative embodiment, the video surveillance system comprises a panning camera and the frames of the video are arranged in a mosaic. Object motion in the video is detected by means of dense motion vector fields and the predicted position of objects in the mosaic is detected based on the detected object motion. The position of moving objects in the current frame being detected by the panning camera is compared with the predicted position of the objets in the mosaic and if the positions are substantially different, the corresponding object is tagged and highlighted as undergoing unexpected motion. A system is also disclosed for using the dense motion vector fields to control the motion of the panning camera to follow a moving object.

### CROSS REFERENCE TO RELATED APPLICATIONS

This application claims the benefit of application Ser. No. 60/245,710, filed Nov. 6, 2000, invented by Steven D. Edelson and Klaus Diepold, entitled Surveillance Video Enhancement.

### BACKGROUND OF THE INVENTION

This invention relates to surveillance video camera systems and more particularly to surveillance video camera systems enhanced by detecting object motion in the video to reduce overload on the operator's attention.

In typical video camera surveillance systems of the prior art, multiple cameras are focused on multiple scenes and the resulting videos are transmitted to a monitoring area where the videos can be observed by the operator. The resulting multiple video motion pictures are simultaneously displayed or are displayed in sequence and it is difficult for the operator to detect when a problem has occurred in the detected scenes because of the large number of scenes which have to monitored. In some systems, a video camera is panned to increase the area that is monitored by a given camera. While such a system provides surveillance over a wide area, only part of the wide area is actually viewed at a given time leaving an obvious gap in the security provided by the scanning camera. To combat this latter problem, one system of the prior art combines the frames generated by the scanning camera into a mosaic so that entire scanned scene is displayed to the operator as an expanded panoramic view. In this system, each new video frame is compared with the previous detected frames displayed in the panoramic view and any differences are outlined thus providing an indication to the operator that the position of an object in the panoramic scene has changed. This system, while an improvement, nevertheless leads to an overload on the operator's attention, since all objects in this panoramic scene which undergo a change in position will be outlined and it is still difficult for the operator to recognize that one or more of the changes may represent a problem which requires attention. In addition, the fact that an object has undergone a change in position in many instances will not be brought to the operator's attention until the camera has completed a scanning cycle and then only if the object location of an which is undergoing a change in position appears in two different frames in a scanning cycle. Accordingly, there is a need for a video camera system which immediately brings to the operator's attention any significant or unexpected motion, which might represent a security problem requiring the operator's immediate attention.

### SUMMARY OF THE INVENTION

In accordance with the present invention a video camera surveillance system is provided with a video processor which has the capability of immediately detecting any object motion in a detected scene and more particularly detecting the occurrence of unexpected motion in a detected scene. In accordance with one embodiment, a plurality of surveillance cameras are provided which feed the videos to a video processing system wherein the videos are analyzed to determine dense motion vector fields representing motion between the frames of each video. From the dense motion vector fields, the motion of individual objects in the detected scenes can be determined and highlighted so that they are brought to the operator's attention. In accordance with the invention, the video processor stores dense motion vector fields representing expected motion in a scene and the dense motion vector field detected from the monitored scene is compared with the stored dense motion vector field representing expected motion to determine whether or not any unexpected motion has occurred. If an object is undergoing unexpected motion, this object will be highlighted in a display of the monitored scene.

In accordance with another embodiment of the invention, the surveillance system comprises a panning camera which pans a wide scene. The frames produced by the video camera are combined into a mosaic representing a panoramic view of the scene scanned by the camera. By means of dense motion vector fields, object motion in the scene being monitored is detected and, based on the detected motion of the objects, the future movement of the objects is predicted. In those portions of the scanned scene not currently being detected by the video camera, the position of the objects undergoing motion is updated in accordance with the predicted motion. Thus the moving objects in the panoramic scene will all be shown undergoing motion and changing position in accordance with the predicted motion. As each new frame of the scanned scene is detected by the video camera, the mosaic is updated with the new frame. If a given object undergoing motion in the current detected scene is substantially displaced from the predicted position when the current detected frame containing such object updates the panoramic scene, such object is tagged as undergoing unexpected motion and the object is highlighted.

In the system of the invention, the scanning speed is sufficiently slow that each part of the scene will be detected several times during each scan so that any objects undergoing motion will immediately detected. Any object undergoing exceptional motion such as moving at a high rate of speed or not corresponding to expected motion as represented by stored dense motion vector fields, may also be highlighted in the currently detected frames as shown in the displayed panoramic scene.

By only highlighting unexpected motion or exceptional motion, the system of the invention prevents overload on the operator's attention and only brings to the operator's attention those situations in the surveilled scene which require his immediate attention and action.

### BRIEF DESCRIPTION OF THE DRAWINGS

FIG. 1 is a block diagram of a surveillance video camera system in accordance with one embodiment of the invention.

FIG. 2 is a flow chart illustrating the video processing carried out by the video processing system in the embodiment of FIG. 1.

FIG. 3 illustrates a display created by the system in FIG. 1 wherein a moving object may be highlighted by showing a telescopic enlarged view of an area around a moving object.

FIG. 4 illustrates another display which may be provided by the surveillance system shown in FIG. 1.

FIG. 5 is a block diagram of another embodiment of the present employing a scanning video camera.

FIG. 6 is an illustration of a mosaic display created by the system of FIG. 5.

FIG. 7 is a flow chart illustrating the process carried out by the video processor by the system in FIG. 5.

### DESCRIPTION OF PREFERRED EMBODIMENTS

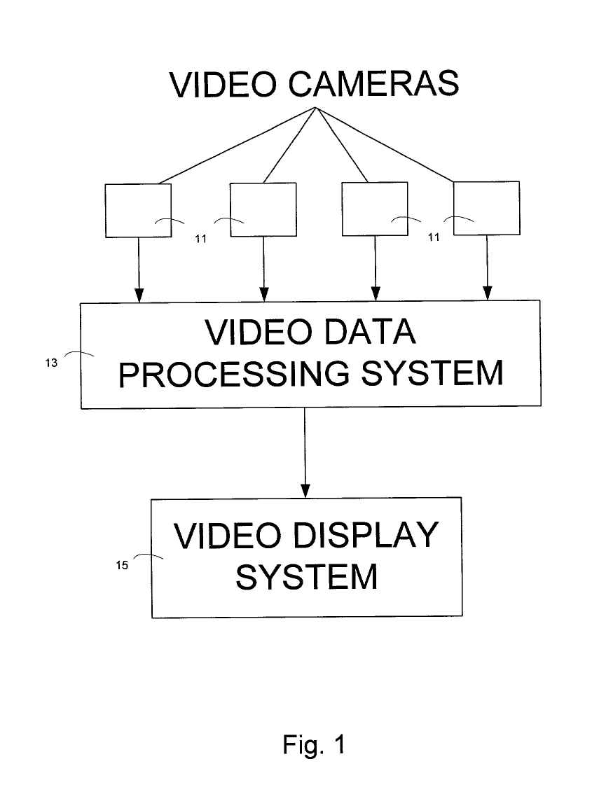

In the system of the invention as shown in FIG. 1 a plurality of video cameras 11 are each arranged to detect a video image of an area to be monitored by the video camera surveillance system. Each camera will send a sequence of video frames showing the corresponding monitored area to a video data processing system 13. The video data processing system typically will comprise a video processor for each video camera but a high speed video processor could be employed to process the sequence of video frames received from each of the cameras simultaneously. The video data processing system detects object motion represented in the video received from each camera, highlights selected moving objects in the video, and transmits the resulting video to a video display system 15 in which the video from the four cameras are displayed. The video display system may be a separate monitors to display the videos simultaneously, or the videos may be all simultaneously displayed on the screen of the single monitor. Alternatively, the videos from the separate cameras may be displayed in sequence on one or more video monitors.

In preferred embodiments, the video processor will detect unexpected motion of objects in the videos and will highlight the objects undergoing this unexpected motion. Objects undergoing motion which is expected, may be highlighted in a different way than the way the unexpected motion is highlighted.

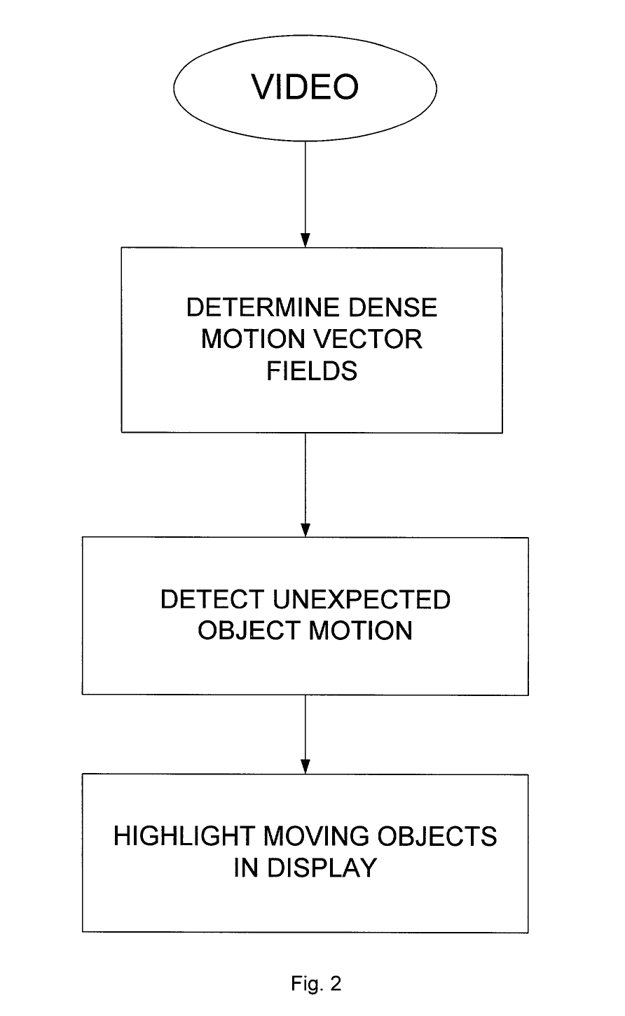

A flow chart of the process carried out by the video processing system 13 on a video received from one of the cameras in shown in FIG. 2. As shown in this Figure, the video from one of the cameras is first processed to detect dense motion vector fields representing the motion of image elements in the received video. Image elements are pixel sized components of objects depicted in the video and a dense motion vector field comprises a vector for each image element indicating the motion of the corresponding image element. A dense motion vector field will be provided between each pair of adjacent frames in the video representing the motion in the video from frame to frame. The dense motion vector fields are preferably generated by the process disclosed in co-pending application Ser. No. 09/593,521 entitled “System for the Estimation of Optical Flow”, filed Jun. 14, 2000 and invented by Sigfriend Wonneberger, Max Griessl and Markus Wittkop. This application is hereby incorporated by reference.

From the dense motion vector fields, the moving objects in the video are identified and are selectively highlighted. In a simplified version of the invention, all moving objects could be highlighted simply by changing a characteristic of all of the pixels in each video frame corresponding to a motion vector having a substantial magnitude. This operation would highlight any moving object in the video, but would subject the operator's perception to overload since significant motion requiring the operators attention would be, in many cases, overwhelmed by detected motion which does not require the operators attention such as expected motion or trivial motion. This problem can be dealt with in a simplified version of the invention by storing in the video processor dense motion vector fields representing expected motion in the video. The dense motion vector fields generated from the current video are then compared with the dense motion vector fields representing the expected motion. The pixels corresponding to motion which is expected are then highlighted with one form of highlighting or not highlighted and the pixels corresponding to unexpected motion are highlighted with different form of highlighting.

In a preferred embodiment, the dense motion vector fields are analyzed to identify the pixels of individual moving objects. In the case of a moving object, the dense motion vector fields for the image elements of the object will all be similar. For example, if the object is moving linearly, the dense motion field vectors of the image elements of the object will all be parallel and of the same magnitude. If the object is rotating about a fixed axis, the dense motion vector field for the image elements of the object will be tangential around the center of the rotating object and will increase in magnitude from the center the edge of the moving object. If an object is not moving linearly, the dense motion vector field pattern for the object will be more complex, but nevertheless will fall into an easily recognized pattern. The video processor identifies sets of contiguous pixels which correspond to the dense motion field vectors representing a moving object. These pixels will then correspond to the image elements of the moving object.

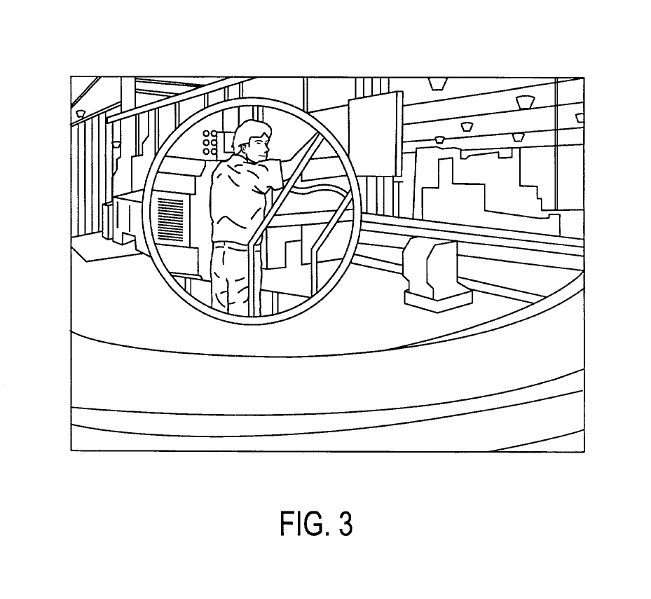

In the preferred embodiment, the video processor will store the dense motion vector fields representing expected motion in the scene detected by the video camera, such as the motion of a fan, the motion of a rotisserie, or the motion of people walking along a walkway. When the detected object motion corresponds to the stored motion vectors representing expected motion, the video processor highlights the pixels of the object undergoing the expected motion in one selected way, such as tinting the pixels of the object undergoing expected motion blue. Alternatively, the pixels of the object undergoing expected motion could be left unchanged and unhighlighted. When the detected object motion does not correspond to expected motion as represented by the stored dense motion vector fields, the object undergoing the unexpected motion is highlighted in a different way such as being tinted red or surrounded by a halo, or alternatively as being subjected to a telescopic effect. In producing the telescopic effect, the video processor defines a high resolution viewing bubble around the object undergoing the unexpected motion or around the area of the unexpected motion and magnifies it as shown in FIG. 3. The operator may be given the ability to electronically steer the magnified viewing bubble around the scene to more clearly view items of interest. In a preferred embodiment, the unexpected motion is automatically highlighted by changing the pixel characteristic such as color or by adding a halo and then the operator can optionally define the high-resolution viewing bubble around the highlighted object after having his attention drawn to unexpected motion by the original highlighting.

In addition, in the preferred embodiment, the video processor can exclude from the highlighting process any trivial motion such as a motion of a small magnitude or a motion of a small object such as that of a small animal.

In the system as described above, the object having unexpected motion may be highlighted by changing its color, by changing its saturation, by changing it contrast, or by placing a halo around the object. Alternatively, the object may be highlighted by defocusing the background which is not undergoing unexpected motion or by changing the background to a grey scale depiction.

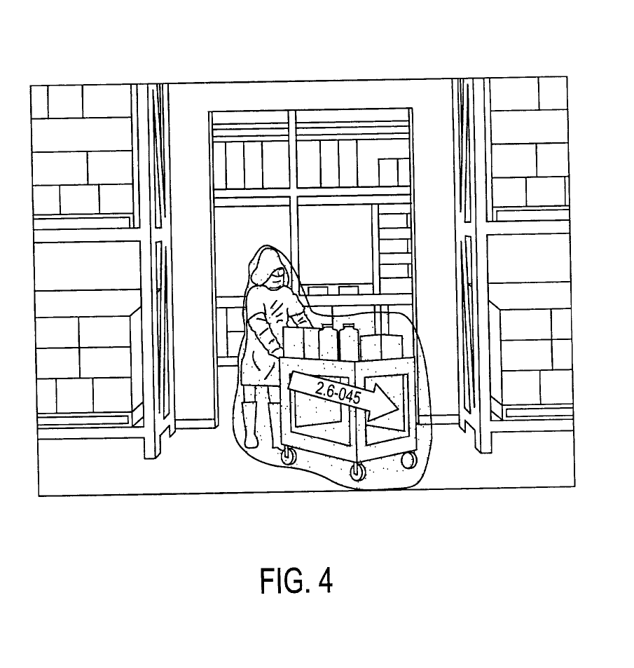

Another feature of the present invention is illustrated in FIG. 4. In accordance with this feature of the invention, a moving object in the display is identified as described above by flagging the contiguous pixels representing the moving object. The velocity of the moving object is then detected from the dense motion vector field vectors representing the motion of the picture elements corresponding to the moving object. Information is then added to the display to indicate the speed and direction of the moving object as shown in FIG. 4. The information may be in the form of an arrow indicating the direction of the motion and containing a legend in the arrow indicating the speed and feet per second and the heading of the object in degrees. In FIG. 4, the cart being pushed by a customer is moving at 2.6 feet per second at a heading of 45°.

In accordance with a further feature of the invention, the position of the flagged moving object at a predetermined time in the future is predicted and the position of the moving object at this future time is then indicated in the display by a graphic representation such as showing a representation of the moving object in outline form.

Additional statistics may also be included in the display such as a time that the object has been shown in the display, the time duration from flagging of the object as a moving object, or other information related to the object motion.

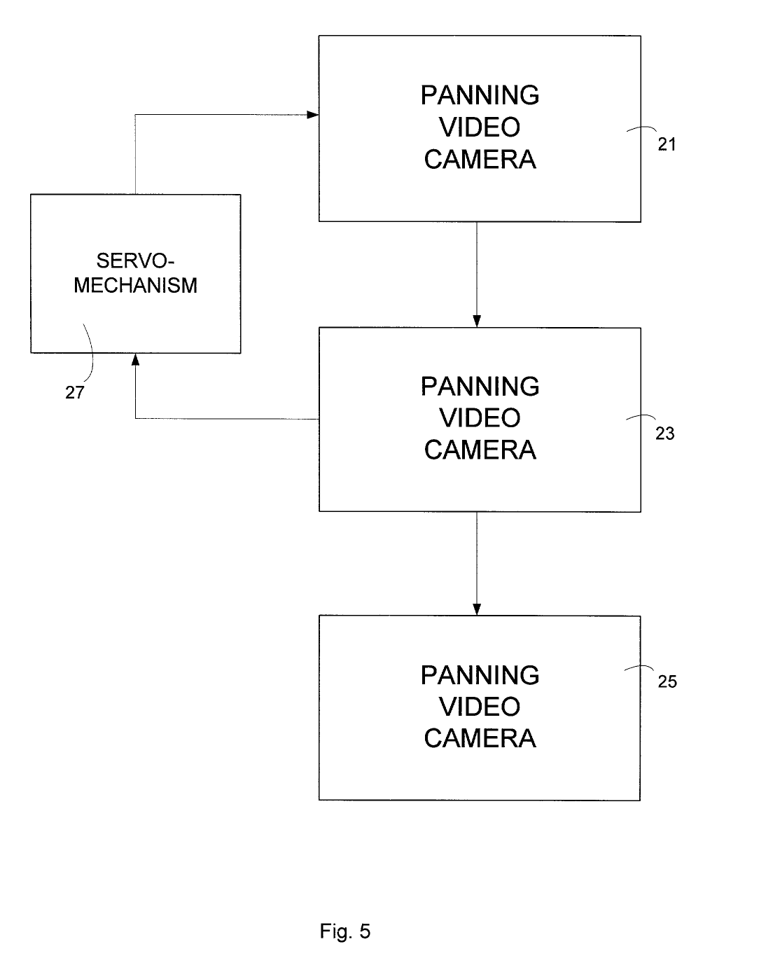

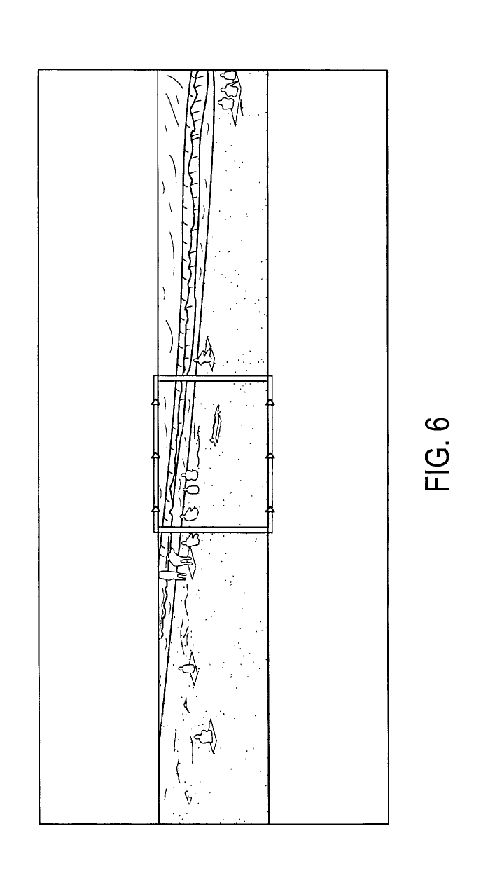

In the embodiment of the invention shown in FIG. 5, a panning camera 21 senses a wide scene by oscillating back and forth to scan the scene. The video produced by the camera is sent to a video processor 23, which arranges the received frames in a mosaic presenting a panoramic view of the scene scanned by the panning camera 21. The mosaic is transmitted to the video display device 25 where the mosaic of the scanned scene is displayed as shown in FIG. 6 so that the viewer can view the entire scene scanned by the camera. As shown in FIG. 6, the display will outline the currently received frame so that the viewer will have the information as to which part of the scanned scene is currently being received by the video camera.

The video processor, in addition to combining the received frames into a mosaic, detects object motion in the scanned scene and from the object motion detects the predicted position of any moving objects in the portions of the scanned scene not currently being detected. The video processor modifies the display of the moving objects in the portion of the scanned scene which are outside of the frame currently being detected by the camera to show the moving objects in their predicted positions in this portion of the scene being scanned. Then when the scanning camera returns to a portion of the scene containing the moving object shown in a predicted position, the position of the moving object will be undated in accordance with currently the detected frame containing a the moving object. In this way, the scene observed by the operator in the entire mosaic will show all the moving objects in their expected positions based on their detected motion.

When the actual position of a moving object is detected by the scanning camera and the object is substantially displaced from its predicted position, the object is tagged as having unexpected motion and the object is highlighted such as by changing its color, by changing its brightness or saturation, by placing a halo around the object, or by magnifying the area around the object to provide a telescopic effect at the location of the object.

The camera is panned to scan the scene at a slow enough rate that so each location, is detected in several sequential frames during the scan of the camera. This feature enables the system of the invention, making use of dense motion vector fields to detect object motion, to detect any object motion during each scan of the scene.

The system of FIG. 5 may also detect unexpected motion by storing dense motions vector fields representing expected motion in the manner described above in connection with the embodiment of FIG. 1. Because the system of FIG. 5 detects object motion immediately, this form of unexpected motion may be immediately highlighted without waiting for the camera to again cycle through the same portion of the scene.

As a result of viewing the entire scanned scene, including predicted object motion in the scene, the operator may wish to get an immediate update of a specific object in the scanned scene. Rather that wait for the panning camera to again reach the object, the operator can cause the camera to snap to that view by means of servomechanism 27 for a real time display of the object of interest and can cause the camera to zoom in on the object if desired.

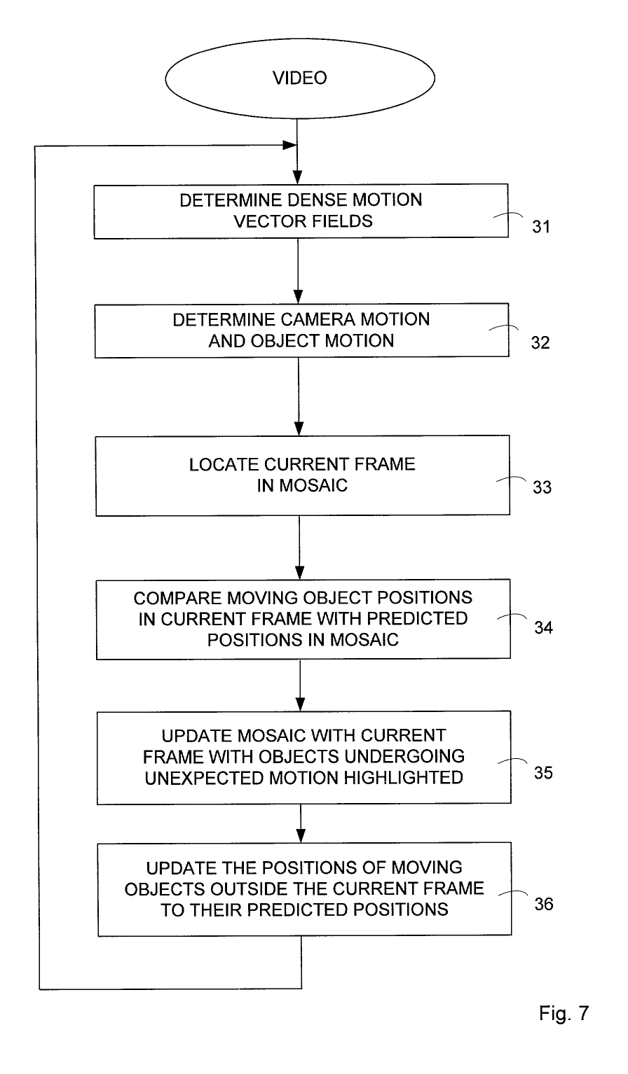

FIG. 7 is a flow chart illustrating the operation of the video processor to make a mosaic of the received picture frames to display the entire scene scanned by the camera and to detect moving objects and to predict and display their predicted positions in the scanned scene. As shown in FIG. 5 the video is first processed in step 31 to detect the dense motion vector fields representing the motion of image elements between the currently detected frame and the adjacent frames in the video. Since the camera is being panned, the dense motion vector field will represent the apparent motion of the background due to the camera motion as well as motion of objects relative to the scene background. From the dense motion vector fields, the camera motion is detected and the motion of objects, separated from the camera motion, is also detected in step 32. To detect the camera motion from the dense motion vector fields, the predominant motion represented by the vectors is detected. If most of the vectors are parallel and of the same magnitude, this will indicate that the camera being moved in a panning motion in the opposite direction to that of the parallel vectors and the rate of panning of the camera will be represented by the magnitude of the parallel vectors. To detect the object motion, vectors corresponding to the camera motion are subtracted from the dense motion vector field vectors detected in the first instance between the adjacent frames. The resulting difference vectors will represent object motion. From the vectors representing object motion, the moving objects in the current frame are identified and their motion is determined. In step 33, the position of the currently detected frame in the mosaic is roughly determined from the detected camera motion. The currently detected frame may then be finely aligned with the mosaic by comparing the pixels at the boundary of the detected frame with the corresponding pixels in the same location in the mosaic. In step 34, the position of the moving objects in the current frame is compared with the predicted positions for these objects in the current frame. As will be explained below, the objects will be displayed in the mosaic in their predicted positions based on their previously detected motion. If the position of an object in the currently detected frame is not approximately the same as its predicted position in the mosaic, the object is tagged as having unexpected motion. In step 35, the mosaic is updated with the recurrent frame by replacing the pixels in the mosaic with the corresponding pixels of the current frame. At this time, the objects tagged in the current frame is undergoing unexpected motion are highlighted. In step 36, the position of all moving objects outside the currently detected frame are undated in accordance with there predicted positions. In this process, the objects which were previously flagged as being moving objects and which are outside of the currently detected frame have their current positions predicted based on the motion determined for the moving objects. To update the position of a moving object, the flagged pixels of the moving object replace the pixels in the mosaic at the predicted position of the moving object. The pixels of the moving object which are not replaced in this process (in the object's previous position) are replaced with corresponding background pixels in the scanned scene. The process then returns to step 31 to determine the dense motion vector field between the next detected video frame and the adjacent video frames and the process then repeats for the next received video frame from the panning camera.

As described above, objects undergoing unexpected motion are highlighted. In addition, any objects undergoing expected motion or undergoing substantial expected motion may be highlighted in a different manner to distinguish them from objects undergoing unexpected motion as described above in connection with the embodiment of FIG. 1.

As described above, the panning camera may be zoomed in and out. While the camera is being zoomed in and out, the action of the camera is considered camera motion and the video frames produced during the zooming or while the camera is in a zoomed in or out state, can be added to the mosaic. In this process the zooming camera motion is detected by the prevailing motion vectors extending radially inwardly or outwardly. Once the camera motion has been detected, the size of the camera frames are adjusted to correspond to that of the mosaic frames and the currently detected frames are then located in the mosaic in the same manner as described above in connection with locating the camera frames produced by the camera panning motion.

In accordance with another feature of the invention, the video processor, controls the operation of servomechanism 27 to cause the panning motion of the camera to follow a moving object and keep the moving object centered in the detected frame. To carry out this control, the video processor determines the predicted immediate future locations of the moving objects. The predicted immediate future locations of the moving object are determined from the dense motion vector field vectors for the moving objects as explained above. By continuously moving the camera to the predicted immediate future locations of the moving object, the camera is made to follow the moving object keeping it centered in the currently detected frame.

In the above described systems, the location of where the videos are displayed may be at a position a long distance from the position of the surveillance cameras. In such an instance, to permit the data to be transmitted over the long distance by telephone line or by the internet, the transmitted data is compressed. In accordance with one embodiment, the video data is processed by a video processor at the location of the surveillance camera or cameras to identify and tag moving objects. Then after video has been transmitted to the display device representing the background being televised by the surveillance camera, subsequent transmissions will only transmit the pixels representing the objects undergoing motion. This compression can be used with either of the embodiments described above.

Alternatively, the successive video frames transmitted to the receiver can be compressed by eliminating selected frames on the cameras side and then recreating these frames on the receivers side as described in co-pending application Ser. No. 09/816,117, filed Feb. 26, 2001, entitled “Video Reduction by Selected Frame Elimination” or alternatively in application Ser. No. 60/312,063, filed Aug. 15, 2001, entitled “Lossless Compression of Digital Video.” These two co-pending applications are hereby incorporated by reference.

The Surveillance Video Camera Systems described above solve the problem of operator overload when a large amount of space has to be monitored by video cameras and makes it possible for the operator to detect and focus on important or unexpected motion when such motion occurs in the scene being monitored by the surveillance cameras.

The above description is a preferred embodiments of the invention and modifications may be made thereto without departed from the spirit and scope of the invention, which is defined in the appendant claims.

What is claimed:

1. A surveillance method comprising detecting a scene to be surveilled with a video camera, processing the resulting video to detect moving objects in the detected scene, distinguishing objects undergoing unexpected motion from objects undergoing expected motion and highlighting the objects undergoing expected motion.

2. A surveillance method as recited in claims 1 further comprising storing representations of motion expected in the detected scene and comparing the motion of moving objects in the detected scene with the stored representations of expected motion to distinguish unexpected motion from expected motion.

3. A method as recited in claim 1 further comprising:
predicting the future positions of the detected moving objects;
comparing the actual positions of the moving objects with the predicted positions; and
identifying an object as undergoing unexpected motion when the positions of such object is substantially different than the predicted position for such object.

4. A method as recited in claim 1 wherein the objects undergoing unexpected motion are highlighted by magnifying the object and the area around the object identified as undergoing unexpected motion.

5. A surveillance method comprising detecting a scene to be surveilled with a video camera, detecting dense motion vector fields representing the motion of image elements from frame to frame in the video produced by said video camera, identifying moving objects depicted in said video by means of said dense motion vector fields and displaying said video with the identified moving objects highlighted in the display of said video.

6. A method as recited in claim 5 wherein a detected moving object is highlighted by magnifying the display of the moving object and the area around the moving object.

7. A surveillance method comprised of panning a video camera to detect a scene, combining the frames of the resulting video into a mosaic representing a panoramic view of said scene, detecting the motion of moving objects in said scene, determining the predicted position of objects in said scene determined from the detected motion of said objects, and updating the position of said moving objects in accordance with the predicted motion of said moving objects in said mosaic.

8. A surveillance method as recited in claim 7 further comprising comparing the position of detected moving objects in the current video frame detected by said video camera with the predicted position for said moving objects and flagging said moving objects as having said unexpected motion when the position of said objects in the current frame is substantially different than the predicted position for such objects.

9. A surveillance method as recited in claim 8 further comprising highlighting in said mosaic the objects flagged as having unexpected said motion.

10. A method of making a video of a moving object comprising detecting a scene containing said moving object, with a video camera to produce a video depicting said moving object, generating dense motion vector fields representing the motion of image elements from frame to frame in said video, determining the motion of said moving object from said dense motion vector field, predicting the immediate future position of said moving object from the detected motion of said moving object, and controlling the motion of said video camera in accordance with the predicted immediate future position of said moving object to maintain the moving object centered in the frame currently being detected by said video camera.

11. A surveillance system comprising a video camera arranged to detect a scene to be survielled, a video processor operable to detect moving objects in the video produced by said video camera and to distinguish objects undergoing unexpected motion from objects undergoing expected motion and to highlight the objects undergoing unexpected motion, and a display device connected to receive the processed video from the video processor to display the processed video with the objects undergoing unexpected motion highlighted.

12. A surveillance system as recited in claim 11 wherein said video processor is provided with a storage capacity which stores representations of expected motion in a detected scene, said video processor comparing the motion of moving objects in a detected scene with the stored representations of expected motion to distinguish unexpected motion from expected motion.

13. A surveillance system as recited in claim 11 wherein said video processor is operable to predict the future positions of the detected moving objects from the motion of the detected moving objects, to compare the actual positions of the moving objects with the predicted positions, and to identify an object as undergoing unexpected motion when the actual position of such object is substantially different than the predicted position for such object.

14. A surveillance system as recited in claim 11 wherein said video processor highlights an object undergoing unexpected motion by magnifying such object and the area around such object identified as undergoing unexpected motion.

15. A surveillance system comprising a video camera arranged to detect a scene to be surveilled to produce a video of said scene, a video processor connected to receive said video and operable to detect dense motion vector fields representing the motion of image elements from frame to frame in said video and to identify moving objects depicted on said video by means of said dense motion vector fields, and to highlight in said video a detected moving object by magnifying the display of the moving object and the area around moving object, and a video display device connected to receive the processed video from said video processor and to display the processed video with the moving object and the area around the moving object being magnified.

16. A surveillance comprising a panning video camera arranged to detect a surveilled scene, a video processor connected to receive the video produced by said video camera and operable to combine the frames of said video into a mosaic representing a panoramic view of said scene, to detect the motion of moving objects in said scene, to determine the predicted position of objects in said scene determined from the detected motion of said objects and to update the position of said moving objects in said video in accordance with the predicted motion of said objects in said mosaic, and a video display device connected to receive the video processed by said video processor and to display said mosaic as a panoramic view of the surveilled scene with the moving objects depicted in their predicted positions.

17. A surveillance system as recited in claim 16, wherein said video processor is further operable to compare the positions of detected moving objects in the frame currently detected by said video camera with the predicted positions of said moving objects, to flag a moving object as having said unexpected motion when the position of such moving object in the current frame is substantially different than the predicted position for such object, and to highlight in said mosaic the object flagged as having unexpected motion whereby the display device displays said mosaic with the object undergoing unexpected motion highlighted.

18. A video system comprising a panning video camera a video processor connected to receive the video produced by said panning video camera and operable to generate dense motion vector fields representing the motion of image elements from frame to frame in the video produced by said video camera, to determine the motion of any depicted moving object in said video from said dense motion vector fields, and to predict the immediate future position of said moving object from the detected motion of said moving object, a controller for controlling the motion of said video camera, said video processor controlling said controller to control the motion of said video camera in accordance with the predicted immediate future position of said moving object to maintain the moving object centered in the frame currently being detected by said video camera.
